(19) United States
(12) Patent Application Publication
(10) Pub. No.: US 2015/0280933 A1
(43) Pub. Date: Oct. 1, 2015

(54) ELECTRONIC DEVICE AND CONNECTION METHOD THEREOF

(71) Applicant: Samsung Electronics Co., Ltd., Gyeonggi-do (KR)

(72) Inventors: Hayoung CHOI, Gyeonggi-do (KR); Heangsu KIM, Incheon (KR); Hongseok MOON, Gyeonggi-do (KR); Hakbong CHO, Gyeonggi-do (KR)

(21) Appl. No.: 14/661,257

(22) Filed: Mar. 18, 2015

(30) Foreign Application Priority Data
Mar. 27, 2014 (KR) 10-2014-0035963

(51) Int. Cl. H04L 12/28; H04W 4/16; H04M 3/54; H04L 29/08

(52) U.S. Cl. CPC H04L 12/2803; H04L 67/10; H04W 4/16; H04M 3/54

(57) ABSTRACT

A method of connecting electronic devices to realize a task connection between applications of the respective devices is provided. A first application is executed by a first electronic device. The first electronic device is connected to a second electronic device through a communication interface during execution of the first application. While the first and second devices are connected, the first device transmits a command including an ID of an application corresponding to the first application to the second electronic device. The second device executes a second application mapped to the ID in response to the command.

### CLAIM OF PRIORITY

This application claims priority from and the benefit under 35 U.S.C. §119(a) of Korean Patent Application No. 10-2014-0035963, filed on Mar. 27, 2014, which is hereby incorporated by reference in its entirety for all purposes as if fully set forth herein.

### BACKGROUND

1. Technical Field

The present disclosure relates generally to an electronic device and a method of connecting electronic devices.

2. Description of the Related Art

With recent advances in electronics and communications, consumers carry and use various electronic devices for a multitude of purposes. For example, users may prefer to use smart home appliances such as personal computers and/or a smart TV at home, and portable terminals such as smart phones outdoors.

Since the electronic devices employed by users are allocated to tasks based on time/place, a technology that supports the continuity of tasks performed by the user has become advantageous. For example, if the user can continuously perform a task involving media contents editing begun with a portable terminal outdoors, and switch the task over to a personal computer when moving indoors, the user can more conveniently complete the task. Furthermore, if the user synchronizes the portable terminal and the personal computer to connect the tasks performed through the portable terminal and the personal computer, the user can continuously perform the previously conducted task and conveniently complete the task through the two separate devices.

### SUMMARY

In order to continuously perform or share a task through a connection between electronic devices, each of the electronic devices should execute a suitable application to perform the task. For example, a task connection between applications for continuing a media editing task is made when each of the devices executes a media editing application in a connection state between the devices.

In this case, a user's control (via input commands) to allow the electronic device to execute the corresponding application is required in conventional methods and the device memory is burdened since the electronic devices should execute the corresponding applications. Furthermore, a user's control is needed conventionally whenever the connection and disconnection between the electronic devices is repeatedly made, and accordingly, the conventional task connection between applications may become onerous.

In accordance with an aspect of the present disclosure, an electronic device capable of performing a task connection with an external device is provided. The electronic device includes a display for displaying an execution screen of a first application; a communication interface configured to support a network connection with the external device; and at least one processor. The at least one processor is configured to control an operation of: while the connection with the external device through the communication interface is recognized during execution of the first application, transmitting a command including an ID of an application corresponding to the first application to the external electronic device through the communication interface. This ID transmission may facilitate the task connection between the two devices.

In accordance with another aspect of the present disclosure, an electronic device is provided. The electronic device includes: a display for displaying an execution screen of an application; a communication interface for supporting a network connection with a an external device; and at least one processor configured to control an operation of: while the connection with the external device is made through the communication interface, receiving a command including an ID of an application from the external device and executing an application mapped to the received ID in response to the command.

In accordance with another aspect of the present disclosure, a method of connecting electronic devices to realize a task connection is provided. A first application is executed by a first electronic device. The first electronic device is connected to a second electronic device through a communication interface during execution of the first application. While the first and second devices are connected, the first device transmits a command including an ID of an application corresponding to the first application to the second electronic device. The second device executes a second application mapped to the ID in response to the command.

A method of connecting electronic devices according to at least some embodiments can achieve a task connection between electronic devices without any user's control when one electronic device executes an application and then becomes connected to another electronic device.

A method of connecting electronic devices according to at least some embodiments can allow one electronic device to automatically execute an application corresponding to an application executed in another electronic device according to a user's selection.

An electronic device that does not support a call network, for example, a 3G and/or LTE network, according to some embodiments, can receive call forwarding from an electronic device supporting the call network and implement a call connection.

### BRIEF DESCRIPTION OF THE DRAWINGS

Aspects, features and advantages of certain embodiments of the present disclosure will be more apparent from the following detailed description in conjunction with the accompanying drawings, in which:

FIG. 1 illustrates a network environment including an electronic device according to an embodiment of the present disclosure;

FIG. 2 is a block diagram of an electronic device according to an embodiment of the present disclosure;

FIG. 3 illustrates a method of connecting electronic device devices according to an embodiment of the present disclosure;

FIG. 4 is a flowchart illustrating a method in which a task of a first electronic device is connected to a task of a second electronic device according to an embodiment of the present disclosure;

FIG. 5 is a flowchart illustrating a method in which a task of a second electronic device is connected to a task of a first electronic device according to an embodiment of the present disclosure; and

FIG. 6 is a flowchart illustrating call forwarding between electronic devices according to an embodiment of the present disclosure.

### DETAILED DESCRIPTION

Hereinafter, the present disclosure will be described with reference to the accompanying drawings. The present disclosure describes various embodiments, and modifications and changes may be made therein. Therefore, embodiments will be described in detail with reference to particular examples shown in the accompanying drawings. However, it should be understood that there is no intent to limit the claimed subject matter to the particular forms, and the claimed subject matter should be construed to cover all modifications, equivalents, and/or alternatives falling within the spirit and scope of the present disclosure. In describing the drawings, similar elements are designated by similar reference numerals.

As used in the present disclosure, the expression “include” or “may include” refers to the existence of a corresponding function, operation, or constituent element, and does not limit one or more additional functions, operations, or constituent elements. Further, as used in the present disclosure, the term such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

As used in the present disclosure, the expression “or” includes any or all combinations of words enumerated together. For example, the expression “A or B” may include A, may include B, or may include both A and B.

While expressions including ordinal numbers, such as “first” and “second”, as used in the present disclosure may modify various constituent elements, such constituent elements are not limited by the above expressions. For example, the above expressions do not limit the sequence and/or importance of the corresponding constituent elements. The above expressions may be used merely for the purpose of distinguishing a constituent element from other constituent elements. For example, a first user device and a second user device indicate different user devices although both are user devices. For example, a first constituent element may be termed a second constituent element, and likewise a second constituent element may also be termed a first constituent element without departing from the scope of the present disclosure.

When a component is referred to as being “connected” or “accessed” to any other component, it should be understood that the component may be directly connected or accessed to the other component, but another new component may also be interposed between them. Contrarily, when a component is referred to as being “directly connected” or “directly accessed” to any other component, it should be understood that there is no new component between the component and the other component.

The terms as used in various embodiments of the present disclosure described herein are merely for the purpose of describing particular embodiments and are not intended to limit the present disclosure. Singular forms are intended to include plural forms unless the context clearly indicates otherwise.

Unless defined otherwise, all terms used herein, including technical terms and scientific terms, have the same meaning as commonly understood by a person of ordinary skill in the art to which the present disclosure pertains. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to the present disclosure may be a device including a communication function. For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smartwatch).

According to some embodiments, the electronic device may be a smart home appliance with a communication function. The smart home appliance as the electronic device, for example, may include at least one of a television, a digital video disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic photo frame.

According to some embodiments, the electronic devices may include at least one of various medical devices (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), an automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) in a shop.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to the present disclosure may be a combination of one or more of the aforementioned various devices. Further, the electronic device according to the present disclosure may be a flexible device. Further, it will be apparent to those skilled in the art that the electronic device according to the present disclosure is not limited to the aforementioned devices.

Hereinafter, an electronic device according to various embodiments of the present disclosure will be discussed with reference to the accompanying drawings. The term “a user” as used in various embodiments may refer to any person who uses an electronic device or any other device (e.g., an artificial intelligence electronic device) using an electronic device.

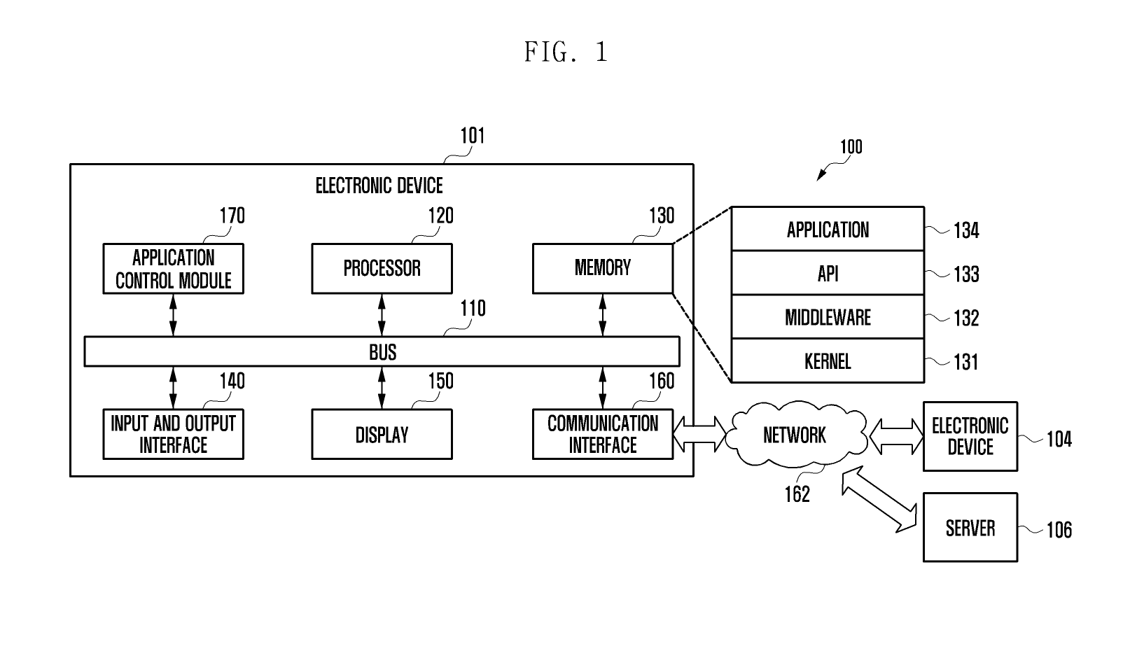

FIG. 1 illustrates a network environment 100 including an electronic device 101 according to various embodiments of the present disclosure. Electronic device 101 may include a bus 110, a processor 120, a memory 130, an input/output interface 140, a display 150, a communication interface 160, and an application control module 170.

The bus 110 may be a circuit interconnecting the aforementioned components and transmitting communication information (e.g., a control message or data) between the aforementioned components.

The processor 120, for example, may receive instructions from the aforementioned components (e.g., the memory 130, the input/output interface 140, the display 150, the communication interface 160, and the application control module 170) other than the processor 120 through the bus 110, decode the received instructions, and perform operations or data processing according to the decoded instructions.

The memory 130 may store instructions or data received from or generated by the processor 120 or other components (e.g., the input/output interface 140, the display 150, the communication interface 160, and the application control module 170). The memory 130 may include programming modules, for example, a kernel 131, middleware 132, an application programming interface (API) 133, and applications 134. Each of the programming modules as described above may be formed by software, firmware, hardware, or a combination of two or more thereof.

The kernel 131 may control or manage system resources (e.g., the bus 110, the processor 120, and the memory 130) used to execute operations or functions implemented in the remaining other programming modules, for example, the middleware 132, the API 133, and the applications 134. Further, the kernel 131 may provide an interface that allows the middleware 132, the API 133, or the applications 134 to access and control or manage individual components of the electronic device 101.

The middleware 132 may serve to mediate between the API 133 or the applications 134 and the kernel 131, that is, allow the API 133 or the application 134 to communicate and exchange data with the kernel 131. Further, the middleware 132 may perform control (e.g., scheduling or load balancing) for task requests received from the applications 134 by using, for example, a method of assigning a priority for use of the system resource (e.g., the bus 110, the processor 120, or the memory 130) of the electronic device 101 to at least one of the applications 134.

The API 133 is an interface for allowing the applications 134 to control functions provided by the kernel 131 and the middleware 132, and may include at least one interface or function (e.g., instruction) for, for example, file control, window control, image processing, or text control.

According to various embodiments, the applications 134 may include an SMS/MMS application, an e-mail application, a calendar application, an alarm application, a health care application (e.g., an application for measuring the amount of exercise or blood glucose), and an environmental information application (e.g., an application for providing atmospheric pressure information, humidity information, temperature information, and the like). Additionally or alternatively, the applications 134 may include an application associated with information exchange between the electronic device 101 and an external electronic device (e.g., the electronic device 104). The application associated with information exchange, for example, may include a notification relay application for transferring specific information to the external electronic device or a device management application for managing the external electronic device.

For example, the notification relay application may include a function of transferring notification information, generated in another application of the electronic device 101 (e.g., the SMS/MMS application, the e-mail application, the health care application, or the environmental information application), to an external electronic device (e.g., the electronic device 104). Additionally or alternatively, the notification relay application, for example, may receive notification information from an external electronic device (e.g., the electronic device 104) and provide the received notification information to a user. The device management application, for example, may manage (e.g., install, remove, or update) a function for at least a part of an external electronic device (e.g., the electronic device 104) communicating with the electronic device 101 (e.g., a function of turning on/off an external electronic device itself (or some components thereof) or adjusting the brightness (or resolution) of a display), an application running on the external electronic device, or a service provided in the external electronic device (e.g., a calling or messaging service).

According to various embodiments, the applications 134 may include an application specified according to the attribute (e.g., type) of an external electronic device (e.g., the electronic device 104). For example, when the external electronic device is an MP3 player, the applications 134 may include an application associated with music playback. Similarly, when the external electronic device is a mobile medical device, the applications 134 may include an application associated with health care. According to an embodiment, the applications 134 may include at least one of an application assigned to the electronic device 101 and an application received from an external electronic device (e.g., the server 106 or the electronic device 104).

The input/output interface 140, for example, may transfer instructions or data, input from a user through an input/output device (e.g., a sensor, a keyboard, or a touch screen), to the processor 120, the memory 130, the communication interface 160, or the application control module 170 through the bus 110. For example, the input/output interface 140 may provide the processor 120 with data corresponding to a user's touch input through a touch screen. Further, the input/output interface 140 may, for example, receive instructions or data from the processor 120, the memory 130, the communication interface 160, or the application control module 170 through the bus 110 and output the received instructions or data through the input/output device (e.g., a speaker or a display). For example, the input/output interface 140 may output voice data processed by the processor 120 to a user through a speaker.

The display 150 may display various pieces of information (e.g., multimedia data or text data) to a user.

The communication interface 160 may establish communication between the electronic device 101 and an external electronic device (e.g., the electronic device 104 or the server 106). For example, the communication interface 160 may be connected to the network 162 through wireless or wired communication and thereby communicate with the external device. The wireless communication, for example, may include at least one of wireless fidelity (WiFi), Bluetooth (BT), near field communication (NFC), a global positioning system (GPS), and cellular communication (e.g., LTE, LTE-A, CDMA, CDMA, UMTS, WiBro, or GSM). The wired communication, for example, may include at least one of a universal serial bus (USB), a high definition multimedia interface (HDMI), Recommended Standard 232 (RS-232), and a plain old telephone service (POTS).

According to an embodiment, the network 162 may be a telecommunications network. The telecommunications network may include at least one of a computer network, the Internet, the Internet of things, and a telephone network. According to an embodiment, a protocol (e.g., a transport layer protocol, a data link layer protocol, or a physical layer protocol) for communication between the electronic device 101 and an external device may be supported by at least one of the applications 134, the application programming interface 133, the middleware 132, the kernel 131, and the communication interface 160.

The application control module 170 may process at least some pieces of information acquired from other components (e.g., the processor 120, the memory 130, the input/output interface 140, and the communication interface 160) and provide the processed information to a user in various ways. For example, the application control module 170 may recognize information on connection components provided in the electronic device 101, store the information on connection components in the memory 130, and execute the applications 130, based on the stored information on connection components. The application control module 170 comprises at least one processor.

Electronic device 104 may have the same or similar construction as electronic device 101.

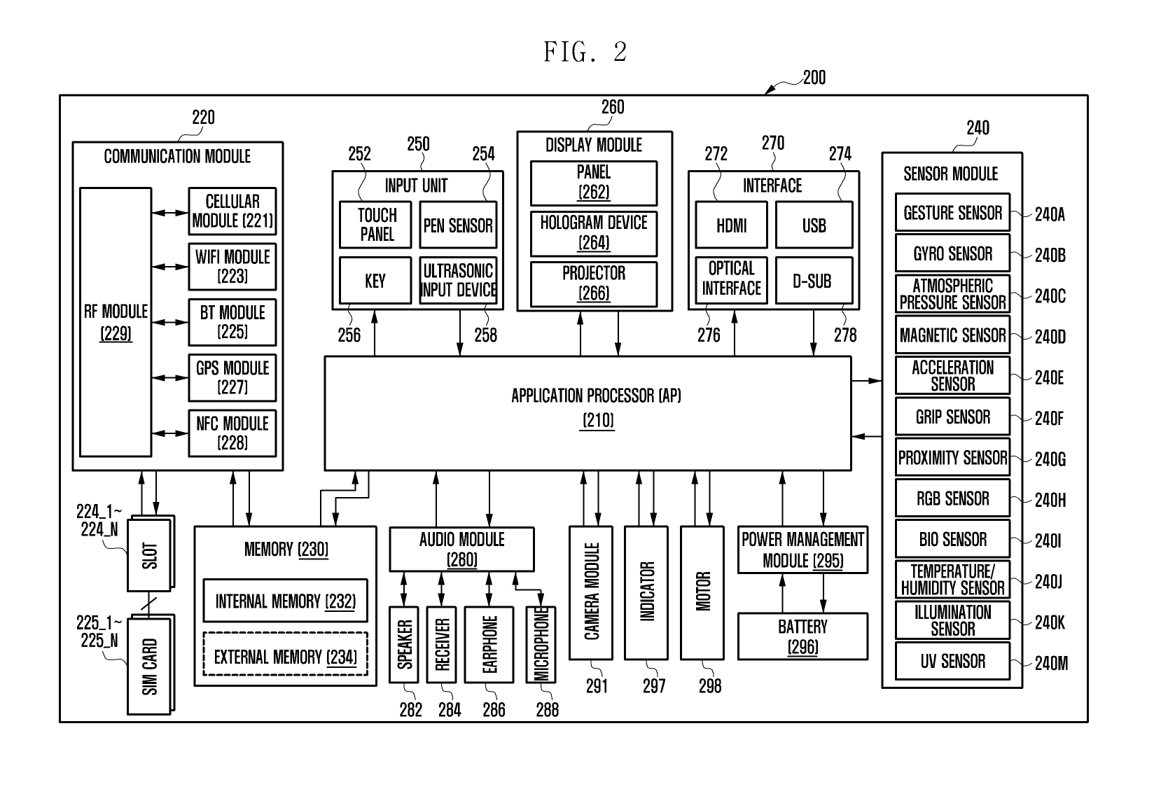

FIG. 2 illustrates a block diagram of an electronic device according to various embodiments. The electronic device 200 is one example of either electronic device 101 or electronic device 104 of FIG. 1 and may constitute all or a part of the electronic device 101 or 104. Electronic device 200 may include at least one application processor (AP) 210, a communication module 220, at least one subscriber identity module (SIM) card slots 224_1˜224_N, a memory 230, a sensor module 240, an input module 250, a display module (“display”) 260, an interface 270, an audio module 280, a camera module 291, a power management module 295, a battery 296, an indicator 297, and a motor 298.

The AP 210, which may perform functions of the application control module 170 and processor 120 of FIG. 1, may drive an operating system or an application program to control a plurality of hardware or software components connected to the AP 210, and may perform processing and operations of various data including multimedia data. The AP 210, for example, may be implemented as a system on chip (SoC). According to an embodiment, the AP 210 may further include a graphic processing unit (GPU) (not shown).

The communication module 220 (e.g., the communication interface 160) may perform data transmission/reception in communication with other electronic devices (e.g., the electronic device 104 and the server 106) connected to the electronic device 200 (e.g., the electronic device 101) through a network. According to an embodiment, the communication module 220 may include a cellular module 221, a WiFi module 223, a BT module 225, a GPS module 227, an NFC module 228, and a radio frequency (RF) module 229.

The cellular module 221 may provide a voice call, a video call, an SMS service, an Internet service, and the like through a communication network (e.g., LTE, LTE-A, CDMA, WCDMA, UMTS, WiBro, or GSM). Also, the cellular module 221 may identify and authenticate an electronic device in a communication network by using, for example, a subscriber identification module (e.g., the SIM card). According to an embodiment, the cellular module 221 may perform at least some of the functions that may be provided by the AP 210. For example, the cellular module 221 may perform at least a multimedia control function.

According to an embodiment, the cellular module 221 may include a communication processor (CP). Further, the cellular module 221, for example, may be implemented as a SoC. Although the cellular module 221 (e.g., a CP), the memory 230, the power management module 295, and the like are shown as separate elements from the AP 210 in FIG. 2, the AP 210 may be implemented to include at least some (e.g., the cellular module 221) of the aforementioned elements according to an embodiment.

According to an embodiment, the AP 210 or the cellular module 221 (e.g., a CP) may load a command or data received from at least one of a non-volatile memory and other elements connected thereto into a volatile memory and process the loaded command or data. Further, the AP 210 or the cellular module 221 may store data received from or generated by at least one of other elements in a non-volatile memory.

Each of the WiFi module 223, the BT module 225, the GPS module 227, and the NFC module 228, for example, may include a processor for processing data transmitted or received through the corresponding module. Although the cellular module 221, the WiFi module 223, the BT module 225, the GPS module 227, and the NFC module 228 are shown as separate blocks in FIG. 2, at least some (e.g., two or more) of the cellular module 221, the WiFi module 223, the BT module 225, the GPS module 227, and the NFC module 228 may be included in one integrated chip (IC) or one IC package according to an embodiment. For example, at least some of processors corresponding to the cellular module 221, the WiFi module 223, the BT module 225, the GPS module 227, and the NFC module 228 respectively (e.g., a CP corresponding to the cellular module 221 and a WiFi processor corresponding to the WiFi module 223) may be implemented as one SoC.

The RF module 229 may perform data transmission/reception, for example, RF signal transmission/reception. Although not shown in the drawing, the RF module 229, for example, may include a transceiver, a power amp module (PAM), a frequency filter, a low noise amplifier (LNA), and the like. Also, the RF module 229 may further include a component for transmitting/receiving an electromagnetic wave over the air in wireless communication, such as a conductor or a conducting wire. Although FIG. 2 shows that the cellular module 221, the WiFi module 223, the BT module 225, the GPS module 227, and the NFC module 228 share one RF module 229, at least one of the cellular module 221, the WiFi module 223, the BT module 225, the GPS module 227, and the NFC module 228 may perform RF signal transmission/reception through a separate RF module according to an embodiment.

The at least one SIM card 225_1 to 225_N may be a card including a subscriber identification module, and may be inserted into at least one slot 224_{—} 1 to 224_N formed in a certain position of the electronic device. The at least one SIM card 225_1 to 225_N may include unique identification information (e.g., integrated circuit card identifier (ICCID)) or subscriber information (e.g., international mobile subscriber identity (IMSI)).

The memory 230 (e.g., the memory 130 of FIG. 1) may include an internal memory 232 or an external memory 234. The internal memory 232, for example, may include at least one of a volatile memory (e.g., a dynamic RAM (DRAM), a static RAM (SRAM), or a synchronous dynamic RAM (SDRAM)) and a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or an NOR flash memory).

According to an embodiment, the internal memory 232 may be a solid state drive (SSD). The external memory 234 may further include a flash drive, for example, a compact flash (CF), a secure digital (SD), a micro secure digital (Micro-SD), a mini secure digital (Mini-SD), an extreme digital (xD), or a memory stick. The external memory 234 may be functionally connected to the electronic device 200 through various interfaces. According to an embodiment, the electronic device 200 may further include a storage device (or storage medium) such as a hard drive.

The sensor module 240 may measure a physical quantity or detect an operation state of the electronic device 200 and convert the measured or detected information into an electronic signal. The sensor module 240, for example, may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, a light sensor 240K, and a ultraviolet (UV) sensor 240M. Additionally or alternatively, the sensor module 240, for example, may include an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scanner (not shown), and/or a fingerprint sensor (not shown). The sensor module 240 may further include a control circuit for controlling one or more sensors included therein.

The input module 250 may include a touch panel 252, a (digital) pen sensor 254, a key 256, or an ultrasonic input unit 258. The touch panel 252 that recognizes a touch input, for example, may include at least one of a capacitive touch panel, a resistive touch panel, an infrared touch panel, and an acoustic wave touch panel. Also, the touch panel 252 may further include a control circuit. When the touch panel is a capacitive touch panel, it may recognize a physical contact or proximity. The touch panel 252 may also further include a tactile layer. In this case, the touch panel 252 may provide a tactile response to a user.

The (digital) pen sensor 254, for example, may be implemented using a means identical or similar to a means for receiving a touch input from a user or using a separate recognition sheet. The key 256, for example, may include a physical button, an optical key, or a keypad. The ultrasonic input unit 258 is a unit that can identify data by generating an ultrasonic signal through an input tool and detecting a sonic wave through a microphone (e.g., the microphone 688) in the electronic device 600, and is capable of wireless recognition. According to an embodiment, the electronic device 200 may also receive a user input from an external device (e.g., computer or server) connected thereto by using the communication module 220.

The display 260 (e.g., the display 150 of FIG. 1) may include a panel 262, a hologram unit 264, or a projector 266. The panel 262, for example, may be a liquid crystal display (LCD) or an active matrix-organic light emitting diode (AM-OLED). The panel 262, for example, may be implemented to be flexible, transparent, or wearable. The panel 262 may also be incorporated into one module together with the touch panel 252. The hologram unit 264 may show a stereoscopic image in the air by using light interference. The projector 266 may display an image by projecting light onto a screen. The screen, for example, may be located inside or outside of the electronic device 200. According to an embodiment, the display 260 may further include a control circuit for controlling the panel 262, the hologram unit 264, or the projector 266.

The interface 270, for example, may include a high-definition multimedia interface (HDMI) 272, a universal serial bus (USB) 274, an optical interface 276, or a D-subminiature (D-sub) 278. The interface 270, for example, may be included in the communication interface 160 shown in FIG. 1. Additionally or alternatively, the interface 290, for example, may include a mobile high-definition link (MHL) interface, a secure digital (SD) card/multimedia card (MMC) interface, or an infrared data association (IrDA) interface.

The audio module 280 may provide bidirectional conversion between a sound and an electronic signal. At least some elements of the audio module 280, for example, may be included in the input/output interface 140 shown in FIG. 1. The audio module 280, for example, may process sound information input or output through a speaker 282, a receiver 284, earphones 286, or the microphone 288.

The camera module 291 is a device that can take both still and moving images, and according to an embodiment, may include one or more image sensors (e.g., a front sensor or a rear sensor, not shown), a lens (not shown), an image signal processor (ISP) (not shown), or a flash (e.g., an LED or xenon lamp, not shown).

The power management module 295 may manage power of the electronic device 200. Although not shown, the power management module 295, for example, may include a power management integrated circuit (PMIC), a charger IC, or a battery or fuel gauge.

The PMIC, for example, may be mounted in an IC or an SoC semiconductor. Charging methods may be classified into wired charging and wireless charging. The charger IC may charge a battery, and may prevent an overvoltage or excess current from being induced or flowing from a charger. According to an embodiment, the charger IC may include a charger IC for at least one of the wired charging and the wireless charging. Examples of the wireless charging include magnetic resonance charging, magnetic induction charging, and electromagnetic charging, and an additional circuit such as a coil loop, a resonance circuit, and a rectifier may be added for the wireless charging.

The battery gauge, for example, may measure the residual capacity, charge in voltage, current, or temperature of the battery 296. The battery 296 may store or generate electricity, and may supply power to the electronic device 200 by using the stored or generated electricity. The battery 296, for example, may include a rechargeable battery or a solar battery.

The indicator 297 may display a specific status of the electronic device 200 or a part thereof (e.g., the AP 210), for example, a boot-up status, a message status, or a charging status. The motor 298 may convert an electrical signal into a mechanical vibration. Although not shown, the electronic device 200 may include a processing unit (e.g., GPU) for supporting a mobile TV. The processing unit for supporting a mobile TV may process media data pursuant to a certain standard, for example, digital multimedia broadcasting (DMB), digital video broadcasting (DVB), or media flow.

Each of the above described elements of the electronic device according to the present disclosure may be formed by one or more components, and the names of the corresponding elements may vary according to the type of the electronic device. The electronic device according to the present disclosure may include at least one of the above described elements, and may exclude some of the elements or further include other additional elements. Further, some of the elements of the electronic device according to the present disclosure may be coupled to form a single entity while performing the same functions as those of the corresponding elements before the coupling.

The term “module” as used in the present disclosure, for example, may mean a unit including one of hardware, software, and firmware or any combination of two or more of them. The “module”, for example, may be interchangeable with the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing certain operations, which are now known or will be developed in the future.

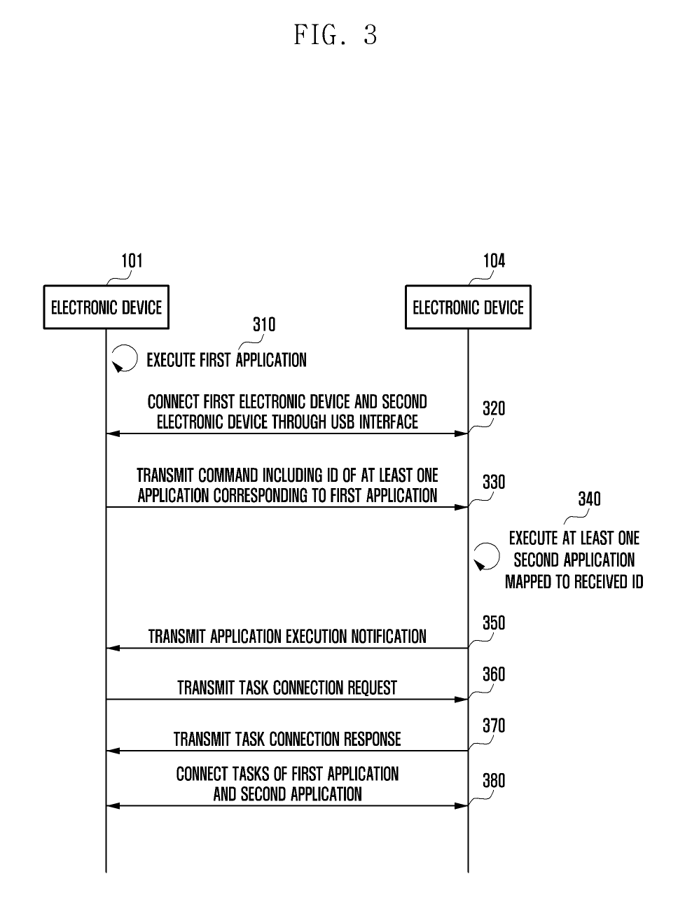

FIG. 3 is a signal flow diagram illustrating a method of connecting electronic device devices according to an embodiment of the present disclosure. The flow diagram of FIG. 3 shows a task connection method between the first electronic device 101 and the second electronic device 104. A “task connection” in one example refers to a connection in which a task state of an application being executed in one electronic device continues in, or is used by, another electronic device, and a user's task performed by the application is shared. A task connection may include all types of links performed through a wired or wireless connection between electronic devices. (The first electronic device 101 and the second electronic device 104 are separated for convenience of the description, but may be connected via wires). In the following description, an electronic device which first executes an application is referred to as the first electronic device 101 and an electronic device which automatically executes an application following a connection to device 101 is referred to as the second electronic device 104. The first electronic device 101 may execute a first application in step 310. For example, the first application may be executed according to a user's control (via input commands). The user may perform various tasks through the first application being executed.

Thereafter, a network connection may be established between the first electronic device 101 and the second electronic device 104 in step 320. For example, the user may physically connect the first electronic device 101 and the second electronic device 104 through a Universal Serial Bus (USB) interface while the first electronic device 101 executes the first application. In this case, wired communication may be made between the first electronic device 101 and the second electronic device 104. Alternatively, the network connection may be made wirelessly using one of the methods noted above (e.g., using a short range communication method such as Bluetooth, WiFi or NFC).

When the connection between the first electronic device 101 and the second electronic device 104 is made, the first electronic device 101 may generate a command including an identification (ID) of at least one application (discussed below) corresponding to the first application being executed and transmit the command to the second electronic device 104 in step 330. For example, the first electronic device 101 may insert the ID of the application corresponding to the first application into a message header and transmit the command to the second electronic device 104. An application “corresponding to” the first application being executed may be a predetermined application automatically selected, or an application selected by the user, which will be described below in detail. The number of applications corresponding to the first application may be one or more. For example, when the first application is a photo album application, the application corresponding to the first application may be at least one of a photo album application, a media editing application, and a contact application (e.g. phone book, telephony, email or messaging application). That is, the application corresponding to the first application may be the first application itself and/or another application related to the first application which may utilize data stored in association with the first application, or vice versa.

The second electronic device 104 may execute an application mapped to the ID included in the command in response to the command received from the first electronic device (step 340). This executed application will be referred to as a “mapped application” or “second application”. (For simplicity of explanation, the following description will refer to one mapped application, but it is understood that plural mapped applications may be executed when plural respective IDs are received.) That is, the second electronic device 104 may automatically execute the second application following a connection with the first electronic device 101, without an additional user input command. For example, when the first application being executed is a photo album application, the second application may be a photo album application, a media editing application, or a contact application that is mapped to the ID. Since the command may include IDs of a plurality of applications, the second electronic device 104 may in this case execute a plurality of second applications mapped to the IDs.

Thereafter, the second electronic device 104 may transmit an application execution notification to the first electronic device 101 (step 350). The first electronic device 101, having received the application execution notification, may then transmit a task connection request to the second electronic device 104 (step 360). In response, the second electronic device 104 may transmit a task connection response that approves the task connection to the first electronic device 101 (step 370).

When the first electronic device 101 receives the task connection response, a task performed by the first application executed in the first electronic device 101 and a task performed by the second application executed in the second electronic device 104 may become connected to each other (step 380). For example, when the first application is a photo album application and the second application is a media editing application, tasks of the two applications may be automatically connected to each other so that an image output from the photo album application of the first electronic device 101 can be edited by the media editing application of the second electronic device 104. Thus a user of the second device may perform media editing using photos stored in association with the photo album application of the first device in substantially the same manner as if the photos were stored on the second device.

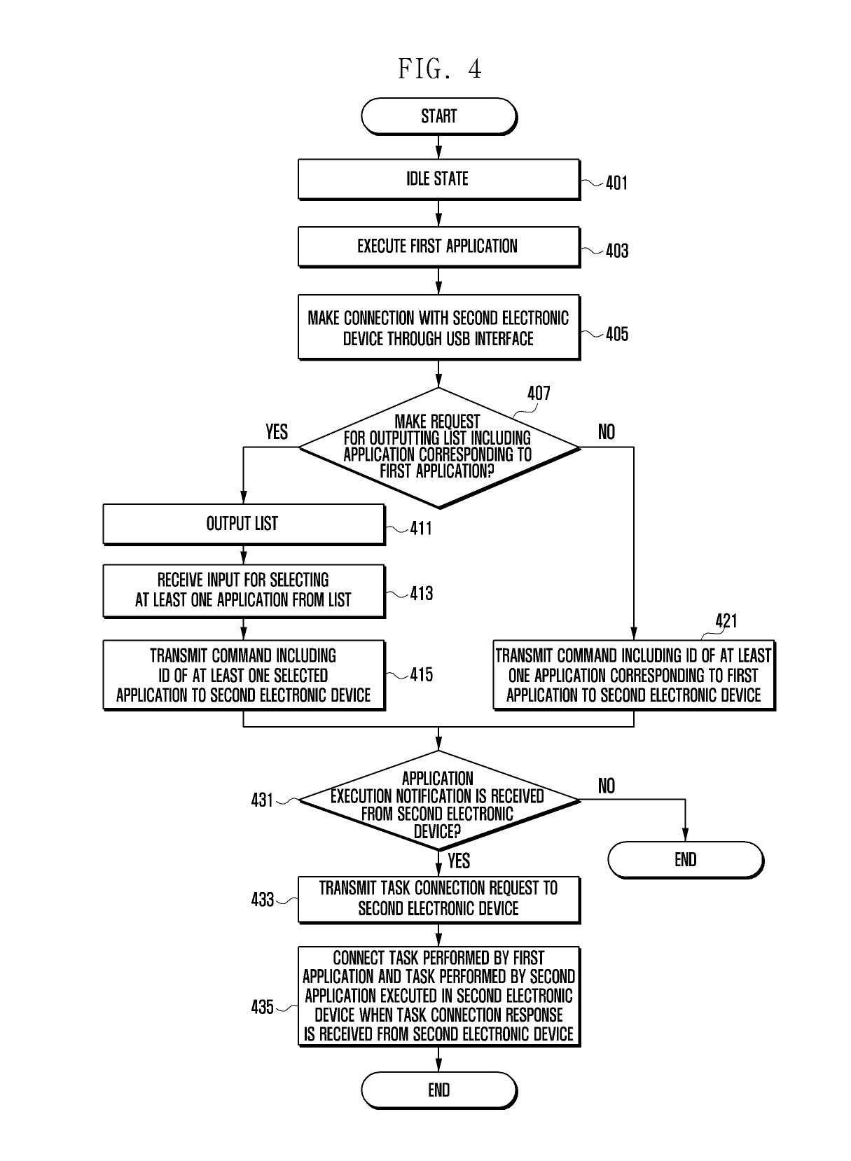

FIG. 4 is a flowchart illustrating a method in which a task of the first electronic device 101 is connected to a task of the second electronic device 104 according to an embodiment. Operations of the method are performed by the first device 101.

The first electronic device 101 may maintain an idle state (step 401). Thereafter, the first electronic device 101 may execute a first application in response to a setting, external input, or user input (step 403). The user may perform various tasks through the first application being executed.

Thereafter, the first electronic device 101 may establish a network connection with the second electronic device 104 while the first application is executed (step 405). For example, the user may physically connect the second electronic device 101 to the first electronic device 101 through a Universal Serial Bus (USB) interface. In this case, wired communication may be made between the first electronic device 101 and the second electronic device 104. For a wireless connection, the user may select a second electronic device to be communicatively connected, via a prompt for a Bluetooth connection or the like upon discovery of the second device in proximity.

When a connection between the first electronic device 101 and the second electronic device 104 is made, there may be a request for outputting a list, including an application corresponding to the first application selectively (step 407). For example, the request may be set up automatically as part of a task connection program controlling the method. That is, the application(s) corresponding to the first application may be predetermined according to a setting or selected by the user.

When there is no request for outputting the list, the first electronic device 101 may generate a command including an ID of at least one application predetermined to correspond to the first application, and transmit the command to the second electronic device 104 (step 421). For example, the first electronic device 101 may insert the ID of the predetermined application(s) corresponding to the first application into a message header and transmit the command to the second electronic device 104.

When there is a request for outputting the list, the first electronic device 101 may output the list on a display in step 411, and receive an input for selecting at least one application from the list through an input/output interface (step 413). Thereafter, the first electronic device 101 may generate a command including an ID of at least one selected application and transmit the command to the second electronic device 104 (step 415). For example, the first electronic device 101 may insert the ID of at least one application selected from the list into the message header and transmit the command to the second electronic device 104.

Thereafter, the first electronic device 101 may determine whether an execution notification of an application mapped to the ID (“second application”, as noted above) is received from the second electronic device 104 (step 431). If the execution notification is not received, this may be due to the second electronic device 104 not having the application mapped to the ID; as a result, the task connection attempt between the electronic devices may end.

However, when the execution notification is received, the first electronic device 101 may transmit a task connection request to the second electronic device 104 (step 433). Thereafter, when the first electronic device 101 receives a task connection response from the second electronic device 104, the first electronic device 101 may connect a task performed by the first application and a task performed by the second application executed in the second electronic device 104 (step 435).

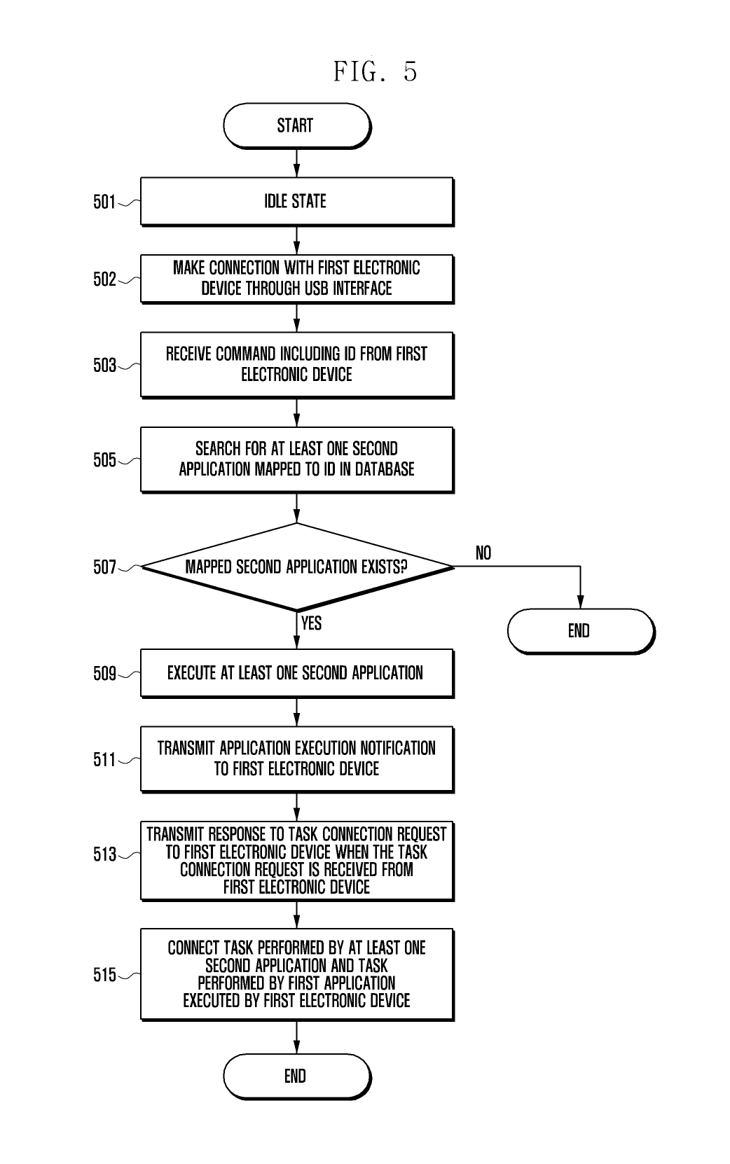

FIG. 5 is a flowchart illustrating a method in which a task of the first electronic device 101 is connected to a task of the second electronic device 104 according to an embodiment. This method is performed by the second electronic device 104.

The second electronic device 104 may maintain an idle state (step 501). In an embodiment, the second electronic device 104 may execute a Multicast Transport Protocol (MTP) application program in the background in the idle state. Thereafter, the second electronic device 104 may establish a network connection with the first electronic device 101 (step 502). For example, the user may physically connect the first electronic device 101 to the second electronic device 104 through a Universal Serial Bus (USB) interface. In this case, wired communication may be performed between the first electronic device 101 and the second electronic device 104. Alternatively, a short range wireless communication connection is established.

When the first electronic device 101 is connected to the second electronic device 104, the second electronic device 104 may receive a command, including one or more IDs from the first electronic device 104 (step 503). (Hereafter, a single ID is described for simplicity of explanation, but it is understood that multiple IDs may be received and multiple second applications may be executed by the second device 104 in response.) The ID may be an ID of at least one application corresponding to the first application executed in the first electronic device 101. The ID may be included in a message header of the command.

The second electronic device 104 may search for at least one second application mapped to the ID in a database in step 505. For example, when the second electronic device 104 receives the command from the first electronic device 101, an MTP application program being executed in the background may search for at least one second application mapped to the ID included in the command. The MTP application program may search for the second application corresponding to the ID based on a program list pre-stored or transmitted from an external source. For example, the database including the program list may be stored in a memory.

In step 507, it may be identified whether or not there is at least one second application mapped to the ID. When there is no second application mapped to the ID, the second electronic device 104 may end the process since a task connection with the first electronic device 101 cannot be made. However, when there is at least one second application mapped to the ID, the second electronic device 104 may execute at least one second application (step 509). For example, the MTP application program may execute at least one second application that is found. Furthermore, the MTP application program may transmit an application execution notification to the first electronic device 101 (step 511). For example, the MTP application program may transmit the application execution notification in an MTP command type to the first electronic device 101.

Thereafter, when the second electronic device 104 receives a task connection request from the first electronic device 101 in step 513, the second electronic device 104 may transmit a task connection response to the first electronic device 101 to approve the task connection request (step 513).

When the task connection response is transmitted to the first electronic device 101, the task performed by at least one second application and the task performed by the first application executed in the first electronic device 101 may be connected, as described earlier.

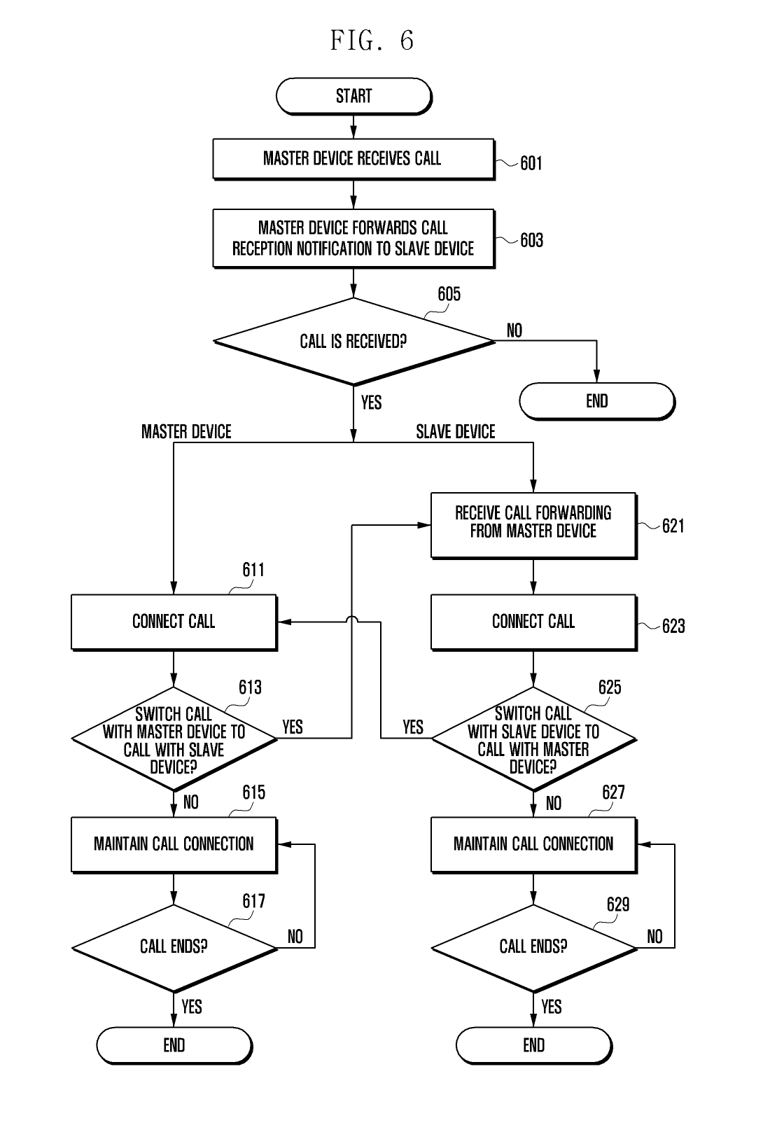

FIG. 6 is a flowchart illustrating a call forwarding method between electronic devices according to an embodiment. In this example, a call forwarding method between the first electronic device 101 and the second electronic device 104 is illustrated. For example, a master-slave relationship as in a Bluetooth or WiFi network may exist between the first and second devices 101, 104. The first electronic device 101 may be a master device operating in a call network, for example, a network such as 3G and/or LTE, and the second electronic device 104 may be a slave device that does not operate in or support the call network. Accordingly, using the method of FIG. 6, the slave device may receive a call connection via routing of a call by the master device, where the call is formed between the master device and an external electronic device through a network with the master device, for example, a WiFi network. The WiFi network between the master device and the slave device may or may not pass through an Access Point (AP).

With continuing reference to FIG. 6, the master device may receive a call from an external device in step 601. Prior to receiving the call, the master device may have performed a task connection with the slave device 104, resulting in the slave device executing a second application corresponding to a first application executed in the master device. The master device may provide the user with a notification indicating a call reception through at least one of a bell, vibration, and message. The master device may forward a message representing call reception notification to the slave device through the network (step 603). The slave device may also provide the user with a notification for informing the user of the incoming call through at least one of a bell, vibration, and message.

In step 605, the master device or slave device may receive the call, in response to user selection of an icon or the like, or, the call may go unanswered when no user input is detected. When the call is not answered, the process ends.

When the master device receives the call, a call between the master device and an external device may be connected (step 611). At this point, the user may answer and handle the call through the master device. During the call connection through the master device, the user may be required or otherwise desire to switch the call connection to a call connection with the slave device. Accordingly, the user may determine whether to switch the call with the master device to the call with the slave device in step 613. For example, the master device may provide the user with a UI including a call switching function, and the user may select call switching through the UI. When the call switching determination is received from the user, a call switching module included in the master device may forward the call to the slave device.

If, at 605, the slave device answers the call by means of user input such as selecting an icon for answering the call, the slave device sends a message indicative of the user selection to the master device. In this case, the master device connects the call at 611 and switches the call to the slave device via call forwarding (steps 613 and 621).

The call forwarding may include voice data forwarding and screen data forwarding. For example, the master device may convert voice data received through a communication network into Voice over Internet Protocol (VoIP) data and transmit the VoIP data to the slave device. The slave device may convert voice signals of the user (received at a microphone of the slave device) to voice data, convert this voice data to VoIP data and transmit this data to the master device. The master device may transmit the VoIP data received from the slave device to an external device through the network. Furthermore, the master device may mirror the screen data of the master device onto the slave device through the network connection.

When call switching to the slave device is not performed, the master device may continuously maintain a call connection in step 615 and may end a call function in step 617 when a call end is received.

When the slave device receives a call in response to a call reception notification, the slave device may receive call forwarding from the master device in step 621. The call forwarding is the same as described above. According to the call forwarding, the call between the slave device and the external device may be connected in step 623. During the call connection through the slave device, the user may be required or otherwise desire to switch the call connection to a call connection with the master device. Accordingly, the user may determine whether to switch the call with the slave device to the call with the master device in step 625. For example, the slave device may provide the user with a UI including a call switching function, and the user may determine call switching through the UI. When the call switching determination is received from the user, a call switching module included in the slave device may forward the call to the master device.

The user may desire to continue using the slave device to handle the call (step 627). The call function and any call forwarding commands terminate at step 629 when the user or other party inputs a command to hang up.

According to various embodiments, at least some of the devices (for example, modules or functions thereof) or methods (for example, operations) according to the present disclosure may be implemented by instructions stored in a computer-readable storage medium in a programming module form. When an instruction is executed by at least one processor (for example, the processor 120), the at least one processor may perform a function corresponding to the instruction. The computer-readable storage medium may be, for example, the memory 130. At least some of the programming modules may be implemented (for example, executed) by, for example, the processor 120. At least some of the programming modules may include, for example, a module, a program, a routine, a set of instructions or a process for performing one or more functions.

Examples of the computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, examples of the program instructions may include high class language codes, which can be executed in a computer by using an interpreter, as well as machine codes made by a compiler. The aforementioned hardware device may be configured to operate as one or more software modules in order to perform an operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Meanwhile, the exemplary embodiments disclosed in the specification and drawings are merely presented to easily describe technical contents of the present disclosure and help the understanding of the present disclosure and are not intended to limit the scope of the appended claims. Therefore, all changes or modifications derived from the technical idea of the present disclosure as well as the embodiments described herein should be interpreted to belong to the scope of the appended claims.

What is claimed is:

1. An electronic device for performing a task connection with an external electronic device, comprising:
a display for displaying an execution screen of a first application;
a communication interface configured to support a network connection with the external device; and
at least one processor configured to control an operation of:
while the connection with the external device through the communication interface is recognized during execution of the first application, transmitting a command including an ID of an application corresponding to the first application to the external electronic device through the communication interface, to facilitate the task connection.

2. The electronic device of claim 1, wherein the at least one processor transmits a task connection request to the external device in response to receiving an execution notification of a second application mapped to the ID from the external device.

3. The electronic device of claim 2, wherein the at least one processor further controls connecting a task performed by the first application and a task performed by the second application mapped to the ID executed in the external device when receiving a response to the task connection request from the external device.

4. The electronic device of claim 1, wherein the at least one processor outputs a list including applications corresponding to the first application through the display.

5. The electronic device of claim 4, further comprising an input/output module for receiving an input for selecting one or more applications from the list, and wherein the at least one processor transmits at least one ID of the one or more applications selected from the list.

6. The electronic device of claim 1, wherein the ID of an application corresponding to the first application is at least one of an ID of the first application or an ID of an application that uses data stored in association with the first application.

7. The electronic device of claim 1, wherein the communication interface includes a Universal Serial Bus (USB) interface.

8. The electronic device of claim 1, wherein, when an input for switching a call to the external device is received during execution of a call application, the at least one processor performs call forwarding to the external device.

9. An electronic device comprising:
a display for displaying an application execution screen;
a communication interface for supporting a network connection with an external device; and
at least one processor configured to control an operation of:
while the connection with the external device is made through the communication interface, receiving a command including an ID of an application from the external device and executing an application mapped to the received ID in response to the command.

10. The electronic device of claim 9, wherein, when the application mapped to the received ID is executed, the at least one processor transmits an application execution notification to the external device through the communication interface.

11. The electronic device of claim 10, wherein, in response to a task connection request received from the external device, the at least one processor is further configured to transmit a response to the task connection request, and to control connecting a task performed by the application mapped to the received ID and a task performed by an application executed in the external device.

12. The electronic device of claim 11, wherein the application executed in the external device is a first application, and the ID of an application received from the external device is an ID of an application corresponding to the first application, and,
the application corresponding to the first application is one of the first application or an application that uses data stored in association with the first application.

13. The electronic device of claim 9, further comprising a memory for storing a database including information on the application mapped to the ID.

14. The electronic device of claim 9, wherein the communication interface includes a Universal Serial Bus (USB) interface.

15. The electronic device of claim 9, wherein the at least one processor receives a call reception notification from the external device through the communication interface, and receives call forwarding from the external device through the communication interface when call reception is accepted in response to the call reception notification.

16. The electronic device of claim 15, wherein, when an input for switching a call to the external device is received during a call connection through the call forwarding, the at least one processor ends the call forwarding.

17. A method of connecting electronic devices, the method comprising:
executing a first application by a first electronic device;
connecting the first electronic device and a second electronic device through a communication interface during execution of the first application;
while the first and second electronic devices are connected, transmitting, by the first electronic device, a command including an ID of an application corresponding to the first application to the second electronic device; and
executing a second application mapped to the ID in response to the command, by the second electronic device.

18. The method of claim 17, further comprising:
transmitting a notification indicating execution of the second application to the first electronic device by the second electronic device;
when the first electronic device receives the notification, transmitting a task connection request to the second electronic device; and
when the second electronic device transmits a response to the task connection request to the first electronic device, connecting a task performed by the first application and a task performed by the second application.

19. The method of claim 17, wherein the transmitting of the command to the second electronic device by the first electronic device comprises:
when the connection with the second electronic device is recognized, outputting a list including applications corresponding to the first application to the first electronic device; and
receiving an input for selecting one or more applications from the list.

20. The method of claim 19, wherein the transmitting of the command to the second electronic device by the first electronic device comprises transmitting the command including one or more ID of the one or more applications selected from the list to the second electronic device by the first electronic device.
